(19) United States
(12) Patent Application Publication
(10) Pub. No.: US 2020/0238777 A1
(43) Pub. Date: Jul. 30, 2020

(54) AIR SPRING WITH INTEGRAL INTERMEDIATE CHAMBER

(71) Applicant: Hendrickson USA, L.L.C., Itasca, IL (US)

(72) Inventors: Damon Delorenzis, Plainfield, IL (US); Jeff R. Zawacki, Channahon, IL (US)

(21) Appl. No.: 16/773,372

(22) Filed: Jan. 27, 2020

Related U.S. Application Data
(60) Provisional application No. 62/798,247, filed on Jan. 29, 2019.

(51) Int. Cl. B60G 11/58; F16F 9/04

(52) U.S. Cl. CPC B60G 11/58; F16F 9/0472; F16F 2222/126; B60G 2206/424; B60G 2206/8101; B60G 2202/15

(57) ABSTRACT

An air spring for a heavy-duty vehicle axle/suspension system comprising a piston, a bellows, and an intermediate chamber integrally formed with the bellows. The bellows has an upper portion, a top plate, and a bellows chamber and is connected to the piston by a band, a bead-in-groove connection, and/or a bayonet connection. The upper portion is reinforced to prevent the bellows chamber from increasing in volume. The intermediate chamber has an optimally sized top plate and a support structure and extends from the piston into the bellows chamber. The intermediate top plate is formed with means for restricted fluid communication between the bellows chamber and the intermediate chamber. The means for restricted fluid communication is not obstructed when it contacts the bellows top plate during jounce events. The support structure is optimized in relation to the top plate.

### CROSS-REFERENCE TO RELATED APPLICATION

This application claims the benefit of U.S. Provisional Patent Application No. 62/798,247, filed Jan. 29, 2019.

### BACKGROUND OF THE INVENTION

### Field of the Invention

The present invention relates generally to the art of axle/suspension systems for heavy-duty vehicles. In particular, the invention relates to heavy-duty vehicle axle/suspension systems that utilize an air spring to cushion the ride of the heavy-duty vehicle. More particularly, the present invention is directed to an air spring with damping characteristics that includes a flexible continuous bellows that forms an upper bellows with a bellows chamber, a rolling portion, and an intermediate bellows, and is optionally mounted to the piston by a bayonet and/or bead-in-groove connection with smooth or textured sealing surface optionally secured together with a retaining band. The upper bellows includes a reinforced portion that prevents radial expansion of the bellows chamber, maintaining the damping energy of the air spring during extreme jounce events. The intermediate bellows extends into, and occupies a portion of, the bellows chamber, providing increased damping energy to the air spring without changing the travel of, or requiring additional space for, the air spring. The intermediate bellows is reinforced with a support structure optimized with respect to the diameter of a reduced size intermediate top plate, which has an optimized means of attachment to the intermediate bellows and is formed with raised, slotted, or castellated openings. The castellated openings allow restricted fluid communication between the bellows chamber and an intermediate chamber during extreme jounce events when the bellows top plate contacts the intermediate top plate.

### Background Art

The use of air-ride axle/suspension systems in heavy-duty vehicles is known. For the purpose of clarity and convenience, reference is made to a heavy-duty vehicle with the understanding that such reference includes trucks, tractor-trailers and semi-trailers, trailers, and the like. Although axle/suspension systems can be found in widely varying structural forms, their structure is generally similar in that each system typically includes a pair of suspension assemblies. The suspension assemblies are typically connected directly to a primary frame of the heavy-duty vehicle or a subframe supported by the primary frame. For those heavy-duty vehicles that support a subframe, the subframe can be non-movable or movable, the latter being commonly referred to as a slider box, slider subframe, slider undercarriage, secondary slider frame, or bogey.

Each suspension assembly of an axle/suspension system includes a longitudinally-extending elongated beam. The beam may extend rearwardly or frontwardly relative to the front of the heavy-duty vehicle, thus defining what are typically referred to as trailing- or leading-arm axle/suspension systems, respectively. However, for the purpose of clarity and conciseness, it is to be understood that the term trailing-arm as used in the instant application encompasses beams which extend either rearwardly or frontwardly with respect to the front end of the heavy-duty vehicle. Each beam typically is located adjacent to and below a respective one of a pair of spaced-apart longitudinally-extending main members and one or more cross members, which form the frame or subframe of the heavy-duty vehicle. For the purpose of clarity and conciseness, reference herein will be made to main members with the understanding that such reference includes main members of primary frames, movable subframes, and non-movable subframes. Each beam is pivotally connected at one of its ends to a hanger, which is attached to and depends from a respective one of the main members of the heavy-duty vehicle. An axle extends transversely between, and typically is connected to, the beams of the pair of suspension assemblies at a selected location from about the mid-point of each beam to the end of the beam opposite its pivotal connection end. An air spring, or other spring mechanism, is connected to, and extends between the beam end opposite the pivotal connection end and a respective one of the main members. A brake system and, optionally, one or more shock absorbers are also mounted on the axle/suspension system.

The axle/suspension systems of the heavy-duty vehicle act to cushion the ride, damp vibrations, and stabilize the heavy-duty vehicle. More particularly, as the heavy-duty vehicle is traveling over the road, the wheels encounter road conditions that impart various forces, loads, and/or stresses, collectively referred to herein as forces, to the respective axle on which the wheels are mounted, and in turn, to the suspension assemblies that are connected to and support the axle. These forces include vertical forces caused by vertical movement of the wheels as they encounter certain road conditions, fore-aft forces caused by acceleration and deceleration of the heavy-duty vehicle as well as certain road conditions, and side-load and torsional forces associated with transverse heavy-duty vehicle movement, such as turning and lane-change maneuvers.

In order to minimize the detrimental effect of these forces on the heavy-duty vehicle during operation, the axle/suspension system is designed to react and/or absorb at least some of these forces. In particular, the axle/suspension system is designed with structural characteristics to address these disparate forces. More particularly, the axle/suspension system is designed to have beams that are fairly stiff in order to minimize the amount of sway experienced by the heavy-duty vehicle and thus provide roll stability, as is known. However, it is also desirable for the axle/suspension system to be relatively flexible to assist in cushioning the heavy-duty vehicle from vertical impacts and provide the axle/suspension system with compliance to resist failure and increase durability. Moreover, it is desirable to damp the vibrations or oscillations that result from these forces. For heavy-duty vehicles, optimal damping of the axle/suspension system is critical in the frequency ranges from about 1.2 to about 2.0 Hz, body bounce mode, and from about 8 to about 15 Hz, wheel hop mode. At these frequencies, the axle/suspension system is predisposed to move such that road inputs at these frequencies may result in a harmonic build-up of movement in the axle/suspension system that can potentially adversely affect the performance of the axle/suspension system.

A key component of the axle/suspension system that cushions the ride of the heavy-duty vehicle from vertical impacts is the air spring. Prior art air springs without damping characteristics generally include three main components: a flexible bellows, a piston, and a bellows top plate. The bellows is typically formed from rubber or other flexible material, and is sealingly engaged with the bellows top plate and the top portion of the piston. The volume of pressurized air, or “air volume”, that is contained within the air spring is a major factor in determining the spring rate, or stiffness, of the air spring. More specifically, this air volume is contained within the bellows and, in some cases, the piston of the air spring. The larger the air volume of the air spring, the lower the spring rate, or stiffness, of the air spring. A lower spring rate, or reduced stiffness, is generally more desirable in the heavy-duty vehicle industry because it decreases vibration transmitted to the main members of the heavy-duty vehicle, allowing for softer ride characteristics.

Prior art air springs without damping characteristics, while adequately cushioning the heavy-duty vehicle cargo and occupant(s) during operation, have potential disadvantages, drawbacks, and limitations. For example, the manner in which prior art air springs secure the bellows to the piston may potentially result in the bellows becoming dislodged or separated from the piston during rebound events. More specifically, during an extreme rebound event, the bellows may become over-extended such that the bottom portion of the bellows may become unsecured from the piston.

Prior art non-damping air springs also provide little, if any, damping characteristics to the axle/suspension system. As a result, damping at critical frequency ranges is typically provided by a pair of hydraulic shock absorbers, although a single shock absorber has also been utilized, as is known. However, these shock absorbers experience changes and limitations in their damping performance. In particular, shock absorbers typically experience changes in performance characteristics over time as they wear, causing changes in the ride and handling characteristics of the heavy-duty vehicle that, in turn, may cause additional wear of the tires and other components of the axle/suspension system over time. More particularly, these changes can potentially increase operational costs of the heavy-duty vehicle. Moreover, the performance of the shock absorbers is typically optimized for a design load of the shock absorbers and does not vary based on payload. Thus, as payload is added or removed from the heavy-duty vehicle, the performance of the shock absorbers may potentially become non-optimal. More specifically, shock absorbers are typically designed for the heaviest expected payload of the heavy-duty vehicle such that the axle/suspension system will become overdamped for lighter loads, potentially increasing wear on the tires and other components of the axle/suspension system. Furthermore, shock absorbers are a service item of the axle/suspension system that require maintenance and/or replacement from time to time, resulting in increased maintenance and/or replacement costs of the axle/suspension system.

Shock absorbers also add varying degrees of complexity and weight to the axle/suspension system. In particular, the amount of cargo that a heavy-duty vehicle may carry is governed by local, state, and/or national road and bridge laws that limit the maximum load that a heavy-duty vehicle may carry as well as the maximum load that may be supported by individual axles of the heavy-duty vehicle. More particularly, because shock absorbers are relatively heavy, the shock absorbers add undesirable weight to the axle/suspension system, thereby reducing the amount of cargo that can be carried by the heavy-duty vehicle.

As a result, prior art air springs with damping characteristics, such as those shown and described in U.S. Pat. No. 8,540,222, and assigned to the Applicant of the instant application, Hendrickson USA, L.L.C., have been developed and may be utilized in heavy-duty air-ride axle/suspension systems. Such prior art damping air springs are generally similar in structure to prior art non-damping air springs and include a piston having a piston chamber. The piston generally has one or more openings extending through a piston top plate such that the openings are capable of providing restricted fluid communication between the bellows and piston chamber.

The restricted fluid communication between the bellows and the piston chamber during heavy-duty vehicle operation provides damping to the axle/suspension system. More specifically, when the axle/suspension system experiences a jounce or rebound event, the bellows is compressed or expanded, respectively, causing the internal pressure of the bellows to increase or decrease, respectively. The change of pressure within the bellows creates a pressure differential between the bellows and the piston chamber. This pressure differential causes air to flow between the bellows and piston chamber through the opening(s) of the piston top plate causing damping to occur.

The separate volumes of air in the bellows and piston chamber of prior art damping air springs are major factors in determining the damping energy of the air spring. Generally, the smaller the bellows volume and the greater the piston volume, the greater the damping energy of the air spring. It is generally more desirable in the heavy-duty vehicle industry for an air spring to have a greater damping energy because it provides a more controlled ride for the heavy-duty vehicle during operation. Thus, a larger piston may be used that extends into, and occupies a portion of, the bellows, reducing the bellows volume and increasing the piston chamber volume, thereby increasing damping energy.

Prior art damping air springs may also include an intermediate chamber that serves as a bumper. In particular, the intermediate chamber is connected to and extends from the piston into, and occupies a part of, the bellows. The intermediate chamber has a top plate that is generally the same size as the piston top plate. One or more openings may be formed in the intermediate chamber top plate to provide restricted fluid communication between the bellows and the intermediate chamber and, thus, to provide additional damping. The intermediate chamber is generally formed separately from the bellows using the same or similar materials. As a result, the intermediate chamber is typically compressible or collapsible such that during extreme jounce events, air spring travel is not limited by the intermediate chamber.

Prior art air springs with damping characteristics, while providing adequate damping to the axle/suspension system of the heavy-duty vehicle, have potential disadvantages, drawbacks, and limitations. For example, as described above, heavy-duty vehicles generally have multiple frequency ranges where optimal damping of the axle/suspension system is critical, such as from about 1.2 to about 2.0 Hz, body bounce mode, and from about 8 to about 15 Hz, wheel hop mode. However, prior art damping air springs generally only provide peak damping characteristics for a single critical frequency range.

In addition, the structure and attachment of the bellows of prior art damping air springs can potentially cause changes in the damping energy of the air spring during jounce events or separation of the bellows from the piston during rebound events. During a jounce event or under increased load, compression of the prior art damping air spring bellows typically increases the tension on the bellows material, potentially causing the bellows material to stretch radially and the bellows diameter to expand beyond a nominal diameter, increasing the volume of the bellows chamber, thereby decreasing the damping energy of the prior art air spring. In addition, during an extreme rebound event, the bellows may become over-extended, such that the bottom portion of the bellows may potentially become unsecured from the piston, potentially causing air loss and/or damage to the prior art air spring and/or other components of the axle/suspension system.

Furthermore, prior art damping air springs with intermediate chambers generally require separate manufacturing and assembly of the intermediate chamber and air spring bellows. The top plates of the intermediate chambers are generally large, and the support mechanisms are typically complex multi-component structures, increasing the weight, complexity, cost of materials and manufacturing, and difficulty of repair and/or replacement of the intermediate chamber. In addition, during extreme jounce events, the support mechanism of the intermediate chamber must be sufficient to prevent undesired or premature collapse of the intermediate chamber in order to maximize damping energy of the air spring. However, the support mechanisms can potentially limit air flow within the piston chamber, obstruct air spring travel, cause damage to the piston, or require additional components. Moreover, embedded support mechanisms for the intermediate chamber are difficult to optimize, potentially resulting in improper or non-optimal stiffness, restriction of air spring travel, or premature collapse of the intermediate chamber and loss of damping energy. During jounce events, the bellows top plate may contact the top plate of the intermediate chamber, potentially obstructing the openings in the top plate of the intermediate chamber, thereby limiting or obstructing fluid flow between the bellows and intermediate chamber. As a result, the damping energy of the air spring can potentially be reduced.

Therefore, it is desirable to have an air spring with damping features that prevents over-expansion of the bellows chamber diameter and separation of the bellows from the piston in extreme jounce events, prevents intermediate chamber collapse due to pressure differentials between the intermediate chamber and the bellows chamber, reduces material and manufacturing costs of the air spring bellows and the intermediate chamber, and allows optimization of support mechanisms of the intermediate chamber without limiting travel or increasing the weight and complexity of the air spring or limiting or obstructing air flow between the bellows and intermediate chamber.

The air spring with damping features for heavy-duty vehicles, according to the present invention, overcomes the disadvantages, drawbacks, and limitations associated with prior art non-damping and damping air springs. The air spring with damping features of the present invention provides a continuous bellows having a reinforced portion that prevents radial expansion of the bellows, maintaining the damping energy of the air spring during extreme jounce events. The air spring with damping features of the present invention also provides a flexible intermediate chamber having an optimized support structure, preventing collapse of the intermediate chamber due to pressure differentials between the intermediate chamber and the bellows chamber. The continuous bellows is attached to the piston utilizing a bayonet and retaining band mechanism and includes the intermediate bellows, which projects into an upper bellows to reduce the volume of the upper bellows, increasing damping energy and reducing the cost of materials and manufacturing without increasing the size or weight of the piston or limiting or changing air spring travel. The air spring of the present invention provides restricted airflow between the flexible intermediate chamber and the upper bellows and between the piston chamber and the flexible intermediate chamber, providing damping characteristics optimized across the body bounce and wheel hop critical frequency ranges to accommodate a broader range of loads and wheel motions, thereby reducing the constraints on the operating range of the air spring while reducing or eliminating frequency dependence and increasing damping energy. The air spring with damping features of the present invention also provides an intermediate chamber top plate with a reduced diameter, optimized means of attachment that securely engages the intermediate chamber bellows, and castellated openings that allow restricted fluid communication between the intermediate chamber and the bellows chamber during extreme jounce events, thereby maintaining the damping of the air spring without increasing the size or weight of the air spring.

### SUMMARY OF THE INVENTION

Objectives of the present invention include providing an air spring having a continuous bellows attached to the piston with an improved connection that prevents separation and/or air loss during rebound events.

A further objective of the present invention is to provide an air spring with increased damping energy by reducing bellows volume without limiting or obstructing travel of the air spring.

Yet another objective of the present invention is to provide an air spring with damping characteristics optimized across body bounce and wheel hop critical frequency ranges, accommodating a broader range of loads and wheel motions and reducing operating constraints and frequency dependence.

Still yet another objective of the present invention is to provide an air spring with an optimized support structure that does not increase the size or weight of the air spring or limit or obstruct the travel of the air spring.

A further objective of the present invention is to provide an air spring with an intermediate chamber that prevents limitation or obstruction of fluid communication between the bellows chamber and intermediate chamber.

Another object of the present invention is to maintain damping energy of the air spring during extreme jounce events.

These objectives and advantages are obtained by the air spring for a heavy-duty vehicle axle/suspension system, according to the present invention, having a piston and a bellows. The bellows has a bellows chamber and is connected to the piston by a band, bead-in-groove connection, and/or a bayonet connection.

These objectives and advantages are also obtained by the air spring for a heavy-duty vehicle axle/suspension system having a piston, a bellows, and an intermediate chamber. The bellows has a bellows chamber. The intermediate chamber has a top plate and a support structure optimized in relation to the top plate.

These objectives and advantages are further obtained by the air spring for a heavy-duty vehicle axle/suspension system having a piston and a bellows. The bellows has an upper portion and a bellows chamber. The upper portion is reinforced to prevent the bellows chamber from increasing in volume.

These objectives and advantages are still further obtained by the air spring for a heavy-duty vehicle axle/suspension system having a piston, a bellows, and an intermediate chamber. The bellows has a bellows chamber and a top plate. The intermediate chamber has a top plate and extends from the piston into the bellows chamber. The intermediate top plate is formed with means for restricted fluid communication between the bellows chamber and the intermediate chamber and is capable of contacting the bellows top plate without obstructing the means for restricted fluid communication during jounce events.

### BRIEF DESCRIPTION OF THE SEVERAL VIEWS OF THE DRAWINGS

The preferred embodiment of the present invention, illustrative of the best mode in which Applicant has contemplated applying the principles, is set forth in the following description, shown in the drawings, and particularly and distinctly pointed out and set forth in the appended claims.

FIG. 1 is a driver-side rear perspective view of an axle/suspension system utilizing a pair of prior art air springs;

FIG. 2 is a perspective view, in section of a prior art air spring without damping characteristics;

FIG. 3 is a perspective view, in section, of a prior art air spring with damping characteristics;

FIG. 4 is an elevational view, in section, of a prior art air spring with damping characteristics, showing an intermediate chamber in restricted fluid communication with the bellows chamber and with the piston chamber via pairs of openings;

FIG. 5 is a perspective view, in section, of an exemplary embodiment damping air spring, according to the present invention;

FIG. 6 is a perspective view of a continuous bellows of the exemplary embodiment damping air spring shown in FIG. 5, showing the continuous bellows orientation as molded prior to installation onto the air spring piston;

FIG. 7A is a greatly enlarged fragmentary perspective view, in section, of the continuous bellows shown in FIGS. 5-6, showing a cut away of a portion of the bellows and the bias angle of the material used;

FIG. 7B is a greatly enlarged fragmentary perspective view, in section, of the continuous bellows shown in FIGS. 5-7A, showing a cut away of a portion of the bellows and a reduced bias angle of the material used;

FIG. 8 is a greatly enlarged fragmentary perspective view, in section, of a portion of the continuous bellows, shown in FIGS. 5-7B, showing the continuous bellows operatively connected to an intermediate chamber top plate;

FIG. 9 is a perspective view, in section, of the continuous bellows shown in FIGS. 5-8, showing the bellows partially inverted, or turned partially inside-out, into the operational orientation and showing the bellows portion of a bayonet connection;

FIG. 10 is a fragmentary perspective view, in section, of the exemplary embodiment damping air spring shown in FIG. 5, showing the intermediate bellows having a support structure and secured to the piston by a retaining band;

FIG. 11 is a fragmentary perspective view, in section, of the exemplary embodiment damping air spring, according to the present invention, showing the intermediate bellows including an alternative support structure integrally formed into the intermediate bellows;

FIG. 12 is a greatly enlarged fragmentary perspective view of the exemplary embodiment damping air spring shown in FIGS. 5 and 10-11, showing the castellated opening of the intermediate top plate; and

FIG. 13 is a greatly enlarged fragmentary elevational view, in section, of the exemplary air spring shown in FIGS. 5, 10, and 12, showing contact between the bellows top plate and the intermediate top plate during an extreme jounce event.

Similar reference characters identify similar parts throughout.

### DESCRIPTION OF THE PREFERRED EMBODIMENT

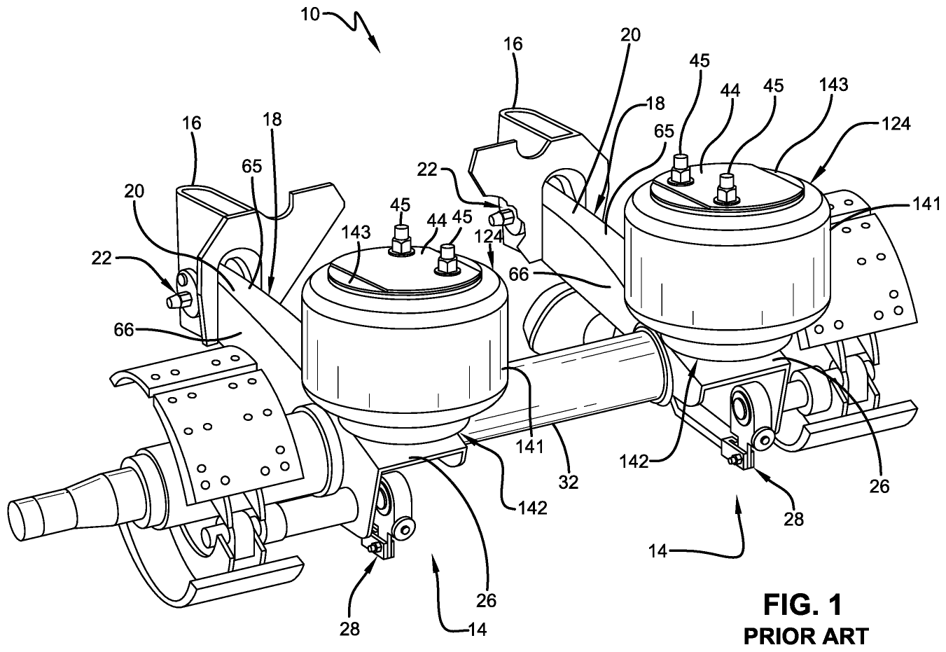

In order to better understand the environment in which the damping air spring of the present invention is utilized, a prior art non-damping air spring 124 (FIG.1) is shown incorporated into a prior art air-ride axle/suspension system 10. Prior art axle/suspension system 10 typically includes a pair of mirror-image suspension assemblies 14 mounted on a pair of longitudinally-extending spaced-apart main members (not shown) of a heavy-duty vehicle (not shown). Because suspension assemblies 14 are mirror-images of each other, for the sake of clarity and conciseness, only one of the suspension assemblies will be described below.

Suspension assembly 14 is pivotally connected to a hanger 16 via a beam 18. More specifically, beam 18 has a pair of sidewalls 66 and a top plate 65 formed in a generally upside-down integral U-shape with the open portion facing generally downwardly. A bottom plate (not shown) extends between and is attached to the lowermost ends of sidewalls 66 by any suitable means, such as welds. Beam 18 includes a front end 20 with a bushing assembly 22 that facilitates a pivotal connection between the beam and hanger 16, as is known. An axle 32 extends between and is connected to each beam 18. Suspension assembly 14 also includes prior art non-damping air spring 124, mounted on and extending between a rear end 26 of beam 18 and the main member of the heavy-duty vehicle. One or more shock absorbers (not shown) may optionally be mounted between beam 18 and hanger 16. For the sake of relative completeness, a brake system 28 is shown mounted on suspension assembly 14.

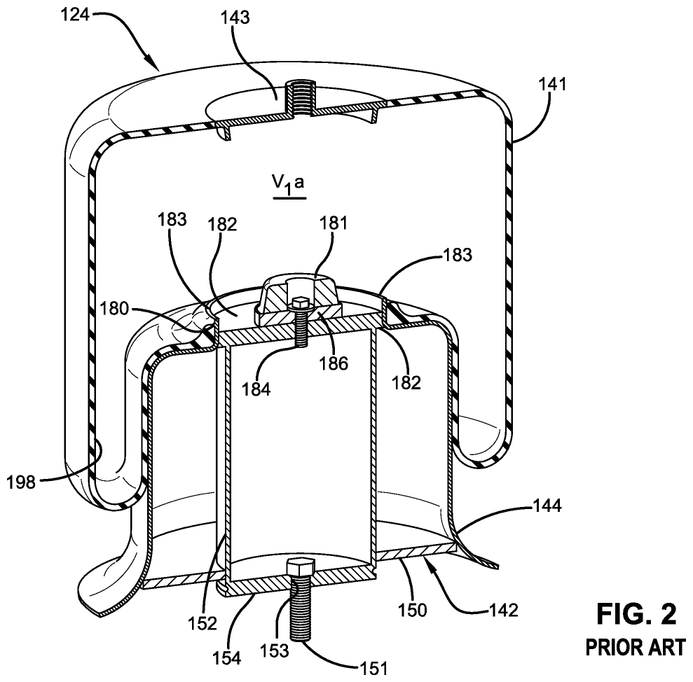

With additional reference to FIG. 2, prior art non-damping air spring 124 includes a bellows 141 and a piston 142. The top portion of bellows 141 is sealingly engaged with a bellows top plate 143, as is known. An air spring mounting plate 44 (FIG. 1) is mounted on top plate 143 by fasteners 45, which are also used to mount the top portion of damping air spring 124 to the heavy-duty vehicle main member. Alternatively, bellows top plate 143 could be mounted directly on a respective one of the main members of the heavy-duty vehicle, as is known.

Piston 142 is generally cylindrical-shaped and includes a continuous generally-stepped sidewall 144 attached to, and extending between, a flat bottom plate 150 and an integrally formed top plate 182. Bottom plate 150 is formed with an upwardly extending central hub 152. Central hub 152 includes a bottom plate 154 formed with a central opening 153. A fastener 151 is disposed through opening 153 in order to attach piston 142 to beam top plate 65 at beam rear end 26. Top plate 182 is formed with a circular upwardly extending protrusion 183 having a lip 180 formed about the circumference of the protrusion. Lip 180 cooperates with the lowermost end of bellows 141 to form an airtight seal between the bellows and the lip, as is known. Bellows 141, top plate 143, and piston top plate 182 define a bellows chamber 198 having an interior volume Via. A bumper mounting plate 186 is mounted on piston top plate 182 by a fastener 184. A bumper 181 is rigidly attached to and extends upwardly from the top surface of bumper mounting plate 186, as is known. Bumper 181 serves as a cushion to prevent contact between piston top plate 182 and bellows top plate 143, which can potentially cause damage to the plates and air spring 124 during air loss or extreme jounce events during operation of the heavy-duty vehicle.

Prior art axle/suspension system 10 is designed to react and/or absorb forces that act on the heavy-duty vehicle during operation. In particular, it is desirable for axle/suspension system 10 to be rigid or stiff in order to resist roll forces and thus provide roll stability for the heavy-duty vehicle. This is typically accomplished by utilizing beam 18, which is rigid and also rigidly attached to axle 32. It is also desirable, however, for axle/suspension system 10 to be flexible to assist in cushioning the heavy-duty vehicle from vertical impacts and to provide the axle/suspension system with compliance to resist failure. Such flexibility is typically achieved through the pivotal connection of beam 18 to hanger 16 with bushing assembly 22. In addition, prior art air spring 124 cushions the ride for cargo and passengers.

Prior art non-damping air spring 124, while providing adequate cushioning to the heavy-duty vehicle cargo and/or occupant(s) during operation, has potential disadvantages, drawbacks, and limitations. For example, during extreme rebound events, bellows 141 may become over-extended such that the lowermost portion of the bellows can potentially become unsecured from lip 180, causing the bellows to detach and/or prior art air spring 124 to lose air pressure, thereby potentially causing damage to the air spring and/or other components of the axle/suspension system.

In addition, prior art air spring 124 does not typically provide any damping to the axle/suspension system. Such damping characteristics are instead typically provided by the shock absorbers (not shown). Where prior art non-damping air spring 124 is utilized without shock absorbers, such as shown in FIG. 1, axle/suspension system 10 is allowed to operate without damping, potentially reducing the service life of the axle/suspension system and its component parts due to excessive wheel bounce during operation of the heavy-duty vehicle. However, even when utilized, shock absorbers add complexity and weight to axle/suspension system 10 and are likely to experience changes and limitations in their damping performance over time. In particular, shock absorbers typically experience changes in performance characteristics over time as they wear, causing changes in the ride and handling characteristics of the heavy-duty vehicle and additional wear of the tires and axle/suspension system 10. More particularly, these changes can potentially reduce service life of components of the heavy-duty vehicle during operation and can potentially increase operational costs of the heavy-duty vehicle over time.

Moreover, the performance of shock absorbers is typically optimized for a design load of the shock absorber and does not vary based on payload. Thus, as payload is added or removed from the heavy-duty vehicle, the performance of the shock absorber may potentially become non-optimal. More specifically, shock absorbers are typically designed for the heaviest expected payload of the heavy-duty vehicle such that axle/suspension system 10 may potentially become overdamped for lighter loads, potentially increasing wear and reducing durability of the tires and axle/suspension system of the heavy-duty vehicle. Furthermore, shock absorbers are a service item that require maintenance and/or replacement from time to time, creating additional maintenance and/or replacement costs for axle/suspension system 10.

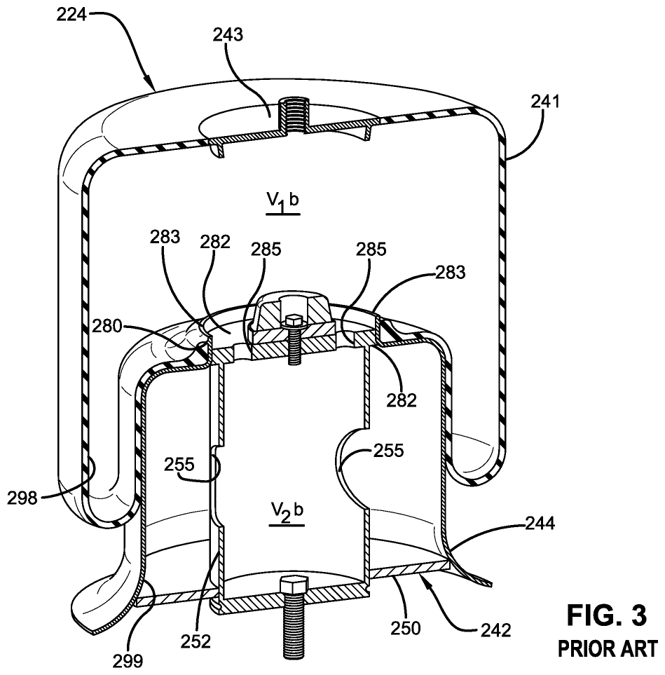

Turning to FIG. 3, a prior art air spring 224 with damping features, such as may be used in prior art axle/suspension system 10, is shown. Prior art air spring 224 is similar in construction and arrangement to prior art air spring 124, described above. As a result, the description below will be primarily directed to the differences between prior art air spring 124 and prior art air spring 224.

Prior art air spring 224 includes a bellows 241, a generally cylindrical-shaped piston 242, and a top plate 243. Piston 242 includes a continuous generally stepped sidewall 244 attached to, and extending between, a flat bottom plate 250 and a top plate 282. Bottom plate 250, sidewall 244, and top plate 282 define a piston chamber 299 having an interior volume V₂b. Bottom plate 250 is formed with an upwardly extending central hub 252. Center support column 252 is generally cylindrical and has one or more openings 255 such that the interior volume of the center support column is continuous with V₂b. Bellows 241, top plate 243, and piston top plate 282 define a bellows chamber 298 having an interior volume V₁b at design ride height. Piston top plate 282 is formed with a circular upwardly extending protrusion 283 having a lip 280 formed about the circumference of the protrusion. Lip 280 cooperates with the lowermost end of bellows 241 to form an airtight seal between the bellows and the lip, as is known. Piston top plate 282 includes a pair of openings 285, which allow bellows chamber 298 and piston chamber 299 to communicate with one another. More particularly, openings 285 allow restricted fluid communication between piston chamber volume V₂b and bellows chamber volume V₁b during operation of the heavy-duty vehicle to provide damping to axle/suspension system 10 at a single critical frequency range.

When axle 32 of axle/suspension system 10 experiences a jounce event, such as when the wheels of the heavy-duty vehicle encounter a curb or a raised bump in the road, the axle moves vertically upwardly toward the heavy-duty vehicle chassis. In such a jounce event, bellows 241 is compressed by axle/suspension system 10 as the wheels of the heavy-duty vehicle travel over the curb or the raised bump in the road. The compression of bellows 241 causes the internal pressure of bellows chamber 298 to increase, creating a pressure differential between the bellows chamber and piston chamber 299. This pressure differential causes air to flow from bellows chamber 298 through openings 285 into piston chamber 299, reducing the pressure differential and causing damping to occur. Air continues to flow back and forth between bellows chamber 298 and piston chamber 299 through openings 285 until pressure within the piston chamber and the bellows chamber have equalized.

Conversely, when axle 32 of axle/suspension system 10 experiences a rebound event, such as when the wheels of the heavy-duty vehicle encounter a large hole or depression in the road, the axle moves vertically downwardly away from the heavy-duty vehicle chassis. In such a rebound event, bellows chamber 298 is expanded by axle/suspension system 10 as the wheels of the heavy-duty vehicle travel into the hole or depression in the road. The expansion of air spring bellows 241 causes the internal pressure of bellows chamber 298 to decrease, creating a pressure differential between the bellows chamber and piston chamber 299. This pressure differential causes air to flow from piston chamber 299 through openings 285 into bellows chamber 298, reducing the pressure differential and causing damping to occur. Air continues to flow back and forth between bellows chamber 298 and piston chamber 299 through openings 285 until pressures within the piston chamber and the bellows chamber have equalized.

Prior art air spring 224 with damping characteristics, while providing adequate damping to axle/suspension system 10, has potential disadvantages, drawbacks, and limitations. For example, prior art air spring 224 uses a relatively small, constant, or fixed piston volume V₂b. Such a limited piston volume V₂b allows for a smaller overall piston chamber 299 and piston 242 that does not require additional space and/or limit the travel of air spring 224 during jounce events. However, bellows chamber volume V₁b of prior art air spring 224 cannot be correspondingly decreased with piston chamber volume V₂b without limiting the travel of the air spring. As a result, the limited piston volume V₂b generally results in a relatively larger bellows chamber volume V₁b, which decreases the damping energy of prior art air spring 224.

Moreover, bellows 241 may potentially expand or extend beyond the intended design parameters of air spring 224 during extreme jounce or rebound events. In particular, when an extreme jounce event occurs, bellows chamber 298 is compressed quickly by axle/suspension system 10, causing pressure in bellows chamber 298 to increase rapidly. More particularly, the rapid pressure increase within bellows chamber 298 causes a larger pressure differential between the bellows chamber and piston chamber 299, radially stretching or expanding and increasing a diameter of bellows 241. This increase in diameter allows bellows chamber volume V₁b to increase while piston chamber volume V₂b is maintained. As a result, the damping energy of air spring 224 is reduced. In addition, when an extreme rebound event occurs, bellows 241 may become over-extended such that the lowermost portion of the bellows can potentially become unsecured from lip 280 of piston top plate 282. As a result, bellows 241 may potentially lose air pressure and/or become dislodged or separated from piston top plate 282 and potentially cause damage to prior art air spring 224 and other components of axle/suspension system 10.

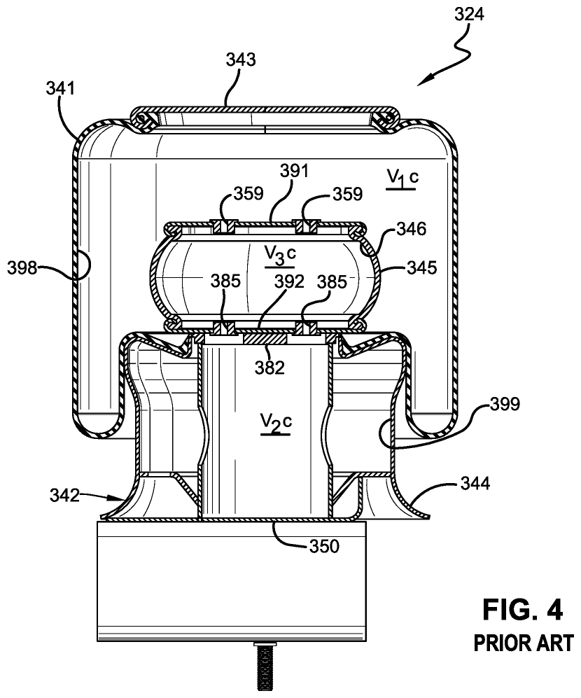

Turning now to FIG. 4, a prior art damping air spring 324, such as may be used in prior art axle/suspension system 10, is shown. Prior art air spring 324 is similar in construction and arrangement to prior art air springs 124, 224 described above. As a result, the description below will be primarily directed to the differences between prior art air spring 124, 224 and prior art air spring 324.

Prior art air spring 324 includes a bellows 341, a bellows top plate 343, an intermediate chamber 346, and a piston 342. Piston 342 is generally cylindrical-shaped and includes a sidewall 344, bottom plate 350, and a top plate 382. Top plate 382, sidewall 344 and bottom plate 350 define a piston chamber 399 having an interior volume Vac. Bellows 341, top plate 343, and piston top plate 382 define a bellows chamber 398 having an interior volume V₁c at design ride height.

Intermediate chamber 346 includes a top wall 391, a bottom wall 392, and a sidewall 345 extending between the top wall and the bottom wall. Top wall 391, bottom wall 392, and sidewall 345 define an intermediate chamber volume Vac of intermediate chamber 346. Intermediate chamber 346 is operatively connected to and extends from piston 342 into bellows chamber 398. More specifically, bottom wall 392 is operatively connected to piston top plate 382. The lowermost end of bellows 341 is operatively engaged with bottom wall 392, piston sidewall 344, and piston top plate 382 so that a lip (not shown) cooperates with the lowermost end of bellows 341 to form an airtight seal between the bellows and the lip, as is known.

Intermediate chamber 346 acts as a bumper and serves as a cushion to prevent contact between piston top plate 382 and bellows top plate 343, which can potentially cause damage to the plates and air spring 324 during air loss or extreme jounce events during operation of the heavy-duty vehicle. Intermediate sidewall 345 is formed from plastic, rubber, or other suitably resilient material. A support mechanism or structure (not shown) is embedded in sidewall 345 or disposed within intermediate chamber 346 and is sufficiently rigid to maintain a constant volume in the intermediate chamber during operation of the heavy-duty vehicle, and is sufficiently resilient to act as a bumper during extreme compression of bellows 341. As a result, prior art air spring 324 has a relatively greater reserved volume between intermediate chamber 346 and piston chamber 399 than prior art air springs 124, 224, while maintaining the full travel height of the air spring.

A pair of generally cylindrical-shaped openings 385 are formed in bottom wall 392 of intermediate chamber 346 and extend through piston top plate 382. Another pair of generally cylindrical-shaped openings 359 are formed in top wall 391 of intermediate chamber 346. Openings 385, 359 are arranged as staged openings in intermediate chamber 346. Openings 385 provide restricted fluid communication between piston chamber 399 and intermediate chamber 346. Openings 359 provide restricted fluid communication between bellows chamber 398 and intermediate chamber 346. The restricted fluid communication between bellows chamber 398, intermediate chamber 346, and piston chamber 399 through openings 385, 359 provides damping characteristics to air spring 324. Additionally, staged openings 385, 359 in intermediate chamber 346 provide air spring 324 with damping characteristics optimized across both body bounce and wheel hop critical frequency ranges, accommodating a broader range of loads and wheel motions and reducing operating constraints and frequency dependence.

When axle 32 of axle/suspension system 10 experiences a jounce event, such as when the heavy-duty vehicle wheels encounter a curb or a raised bump in the road, the axle moves vertically upwardly toward the heavy-duty vehicle chassis. In such a jounce event, bellows 341 is compressed by axle/suspension system 10 as the wheels of the heavy-duty vehicle travel over the curb or the raised bump in the road. The compression of air spring bellows 341 causes the internal pressure of bellows chamber 398 to increase. As a result, a pressure differential is created between bellows chamber 398 and intermediate chamber 346. This pressure differential causes air to flow from bellows chamber 398 through openings 359 into intermediate chamber 346. The flow of air into intermediate chamber 346 causes a pressure differential to form between the intermediate chamber and piston chamber 399. This pressure differential causes air to flow from intermediate chamber 346 through openings 385 into piston chamber 399. The flow of air back and forth from bellows chamber 398 through openings 359, intermediate chamber 346, and openings 385 into piston chamber 399 causes damping to occur. Air continues to flow back and forth among bellows chamber 398, intermediate chamber 346, and piston chamber 399 until the pressures within the piston chamber, the intermediate chamber, and the bellows chamber have equalized.

Conversely, when axle 32 of axle/suspension system 10 experiences a rebound event, such as when the heavy-duty vehicle wheels encounter a large hole or depression in the road, the axle moves vertically downwardly away from the heavy-duty vehicle chassis. In such a rebound event, bellows 341 is extended by axle/suspension system 10 as the wheels of the heavy-duty vehicle travel into the hole or depression in the road. The extension of bellows 341 causes the internal pressure of bellows chamber 398 to decrease. As a result, a pressure differential is created between bellows chamber 398 and intermediate chamber 346. This pressure differential causes air to flow from intermediate chamber 346 through openings 359 and into bellows chamber 398. As a result of air flow from intermediate chamber 346, a pressure differential is formed between piston chamber 399 and the intermediate chamber. This pressure differential causes air to flow from piston chamber 399 through openings 385 into intermediate chamber 346. The flow of air back and forth from piston chamber 399 through openings 385, intermediate chamber 346, and openings 359 into bellows chamber 398 causes damping to occur. Air continues to flow back and forth among piston chamber 399, intermediate chamber 346, and bellows chamber 398 until the pressures within the piston chamber, the intermediate chamber, and the bellows chamber have equalized.

Prior art damping air spring 324, while providing adequate damping to axle/suspension system 10, has potential disadvantages, drawbacks, and limitations. For example, intermediate chamber 346 and the support mechanisms or structures are difficult to manufacture and assemble. Specifically, intermediate chamber sidewall 345 is typically manufactured as a separate component from the same material as bellows 341. In addition, intermediate chamber 346 is typically indirectly secured to piston 342 such that intermediate chamber sidewall 345 is secured to intermediate chamber bottom wall 392, which is, in turn, attached to piston top plate 382, increasing the complexity and cost of materials and manufacturing.

Moreover, the support mechanisms for intermediate chamber 346 are typically non-optimized such that the support mechanisms may limit or block restricted fluid communication between the intermediate chamber and bellows chamber 398 and/or provide insufficient support or insufficient flexibility to the intermediate chamber, thereby decreasing the damping energy of air spring 324 and/or limiting or obstructing the travel of the air spring. In addition, the support mechanism generally requires top wall 391 to be the same diameter as bottom wall 392, increasing the weight of the intermediate chamber. As a result, top plate 391 and bottom wall 392 are difficult to maneuver through the opening of bellows 341, increasing the difficulty of assembly.

Furthermore, during extreme jounce or rebound events, bellows 341 may potentially expand or stretch beyond the intended design parameters or restricted fluid communication between the bellows and intermediate chamber 346 may become obstructed. In particular, when an extreme jounce event occurs, bellows 341 is compressed quickly by axle/suspension system 10, causing pressure in bellows chamber 398 to increase rapidly. More particularly, this rapid pressure increase within bellows chamber 398 causes a relatively larger pressure differential to form between the bellows chamber and piston chamber 399 than occurs during a normal jounce event, stretching or expanding and increasing a diameter of bellows 341. This increase in diameter allows bellows chamber volume V₁c to increase while piston chamber volume Vac is maintained, reducing the damping energy of air spring 324. In addition, during an extreme jounce event, bellows top plate 343 may contact top wall 391 of intermediate chamber 346, potentially obstructing openings 359 and blocking the flow of air between bellows chamber 398 and the intermediate chamber. As a result, the damping energy of prior art air spring 324 may be further reduced. Moreover, when an extreme rebound event occurs, bellows 341 can potentially become over-extended, such that the lowermost portion of the bellows can potentially become unsecured from piston 342. As a result, bellows 341 may potentially lose air pressure and/or become dislodged or separated from piston 342, potentially causing damage to prior art air spring 324 and/or other components of axle/suspension system 10. The air spring with damping characteristics of the present invention overcomes the disadvantages, drawbacks, and limitations of prior art air springs 124, 224, 324 and will be described in detail below.

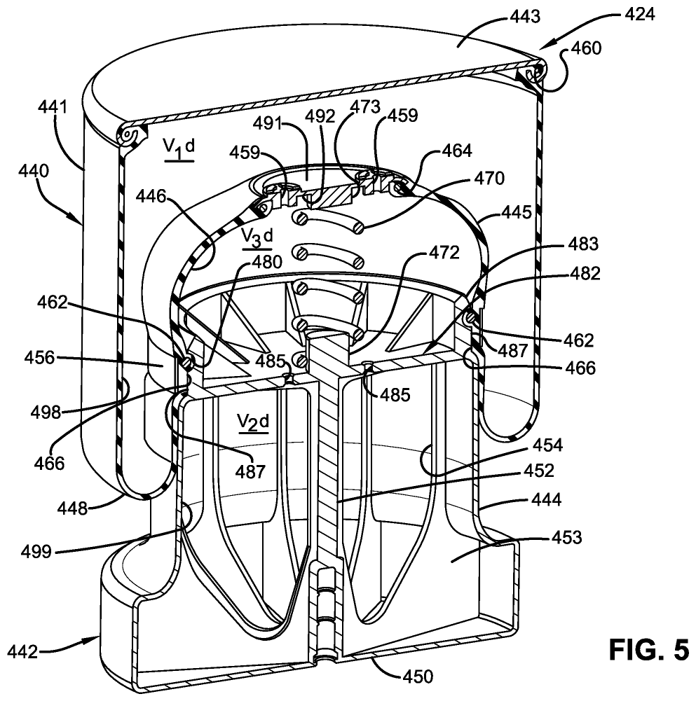

An exemplary embodiment air spring 424 with damping characteristics, according to the present invention, for use in a heavy-duty vehicle axle/suspension system is shown in FIGS. 5-13. Air spring 424 may be incorporated into any suitable axle/suspension system, such as axle/suspension system 10, and includes a piston 442, a bellows 440, a bellows top plate 443, and an intermediate chamber 446.

Piston 442 is generally cylindrical having a generally stepped sidewall 444 connected to, and extending between a bottom plate 450 and a top plate 482. Bottom plate 450, sidewalls 444, and top plate 482 define a piston chamber 499 with an internal volume V₂d. Bottom plate 450 is formed with a generally cylindrical upwardly-extending central hub 452 that is operatively connected to, or integrally formed with, top plate 482. One or more support walls 453 extend radially outward from, and are formed in a circumferentially-spaced arrangement about, central hub 452. Support walls 453 are connected to, and extend between, central hub 452, bottom plate 450, top plate 482, and sidewalls 444. Support walls 453 may each be formed with an opening 454 adjacent to central hub 452. Openings 454 allow fluid communication throughout piston chamber 499 such that piston chamber volume V₂d is continuous. Support walls 453 and central hub 452 also act to distribute forces acting on top plate 482 through piston 442 to bottom plate 450.

Top plate 482 of piston 442 includes a circular upwardly-extending protrusion 483. Protrusion 483 is formed with a groove 480 and a sealing surface 487 extending at least partially about the outer circumference of the protrusion. Groove 480 may be formed with any suitable cross-sectional shape. In addition, groove 480 may be non-continuous having one or more circumferentially-spaced groove segments about protrusion 483 separated by interruptions or areas of material that are level with, or in the same circumferential plane as, the outer circumference of sealing surface 487. Sealing surface 487 is formed adjacent to groove 480 and may be smooth or have any suitable surface feature or series of surface features, such as textures.

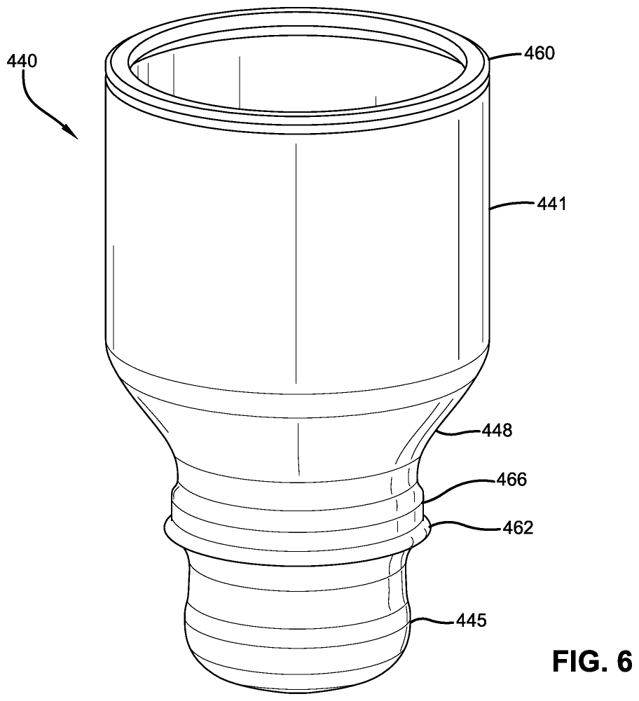

In accordance with one of the primary features of the present invention and with specific reference to FIG. 6, bellows 440 is formed as a single continuous bellows having a reinforced upper bellows 441, a rolling portion 448, and an intermediate bellows 445. Forming upper bellows 441, rolling portion 448, and intermediate bellows 445 as single continuous bellows 440 simplifies and facilitates production and assembly of air spring 424, reducing the cost of materials and manufacturing. Bellows 440 is formed from any suitable flexible or compliant material, such as rubber or plastic, as is known. Bellows 440 is generally formed such that the structure of the bellows has an orientation that is reversed from an operational orientation of the bellows after assembly of air spring 424 is completed. More specifically, during assembly of air spring 424, bellows 440 is disposed over and about piston 442 and is partially or wholly inverted, or turned, inside-out into the operational orientation, such that intermediate bellows 445 and part or all of rolling portion 448 of the bellows are encompassed by upper bellows 441. This manner of assembly allows intermediate bellows 445 to be operatively secured to, and extend from, piston 442 as described in detail below.

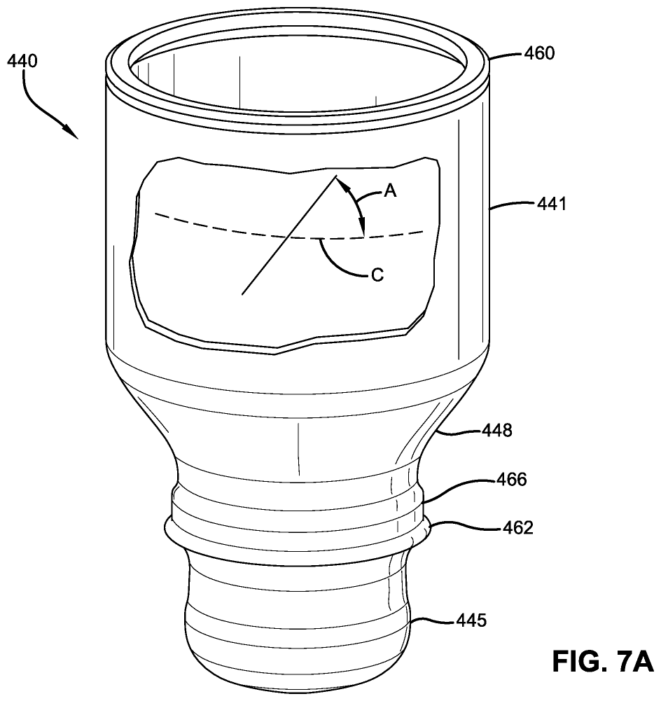

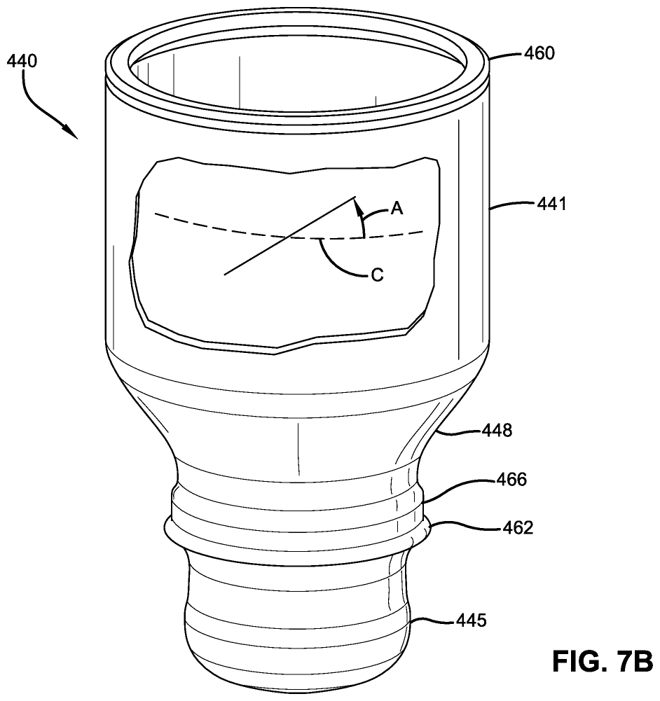

The different portions of bellows 440 may have different or varying physical properties, such as compliance or reinforcement, to allow for optimization of the spring constant, or stiffness, and/or damping effects of air spring 424. Upper bellows 441 may be reinforced using multiple layers of any suitable material, such as polyester, nylon, or cloth cord, or with suitable internal structure, such as rings or mesh, in order to prevent excessive stretching or expansion of upper bellows 441 during jounce events. More particularly, layers of additional material may have a bias angle A (FIG. 7A) with respect to a circumference C of upper bellows 441 that may be narrowed, as shown in FIG. 7B, to provide relatively greater radial reinforcement against diameter growth in the upper bellows. By arranging the fibers of the layers of additional material at a more acute bias angle A relative to each other, the resistance to radial expansion of upper bellows 441 can be customized to prevent changes in diameter of the upper bellows during operation of the heavy-duty vehicle.

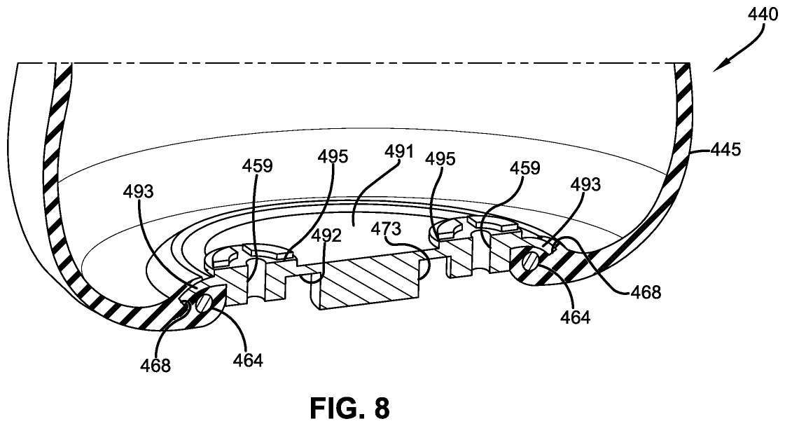

Bellows 440 includes one or more integrally formed circumferential beads or ridges extending radially from the bellows. More specifically, bellows 440 may have an upper bead 460, a middle bead 462, and a lower bead 464. Lower bead 464 extends radially from the lowermost end of bellows 440 and is attached to an intermediate top plate 491 to form the uppermost end of intermediate bellows 445. In particular, lower bead 464 is molded and cured with intermediate top plate 491 during the manufacturing and molding of bellows 440. More particularly, intermediate top plate 491 is generally circular and includes a circumferential flange or outwardly extending projection 493 (FIG. 8). Projection 493 is inserted or molded into a circumferential slot or cleft 468 formed in bellows 440 adjacent to lower bead 464. Projection 493 is cured within cleft 468 with rubber and/or belt material adhesively wrapped around top plate 491, creating a bonded structure securing the projection and bellows 440 together.

Upper bead 460 extends radially from the uppermost portion of bellows 440, and thus the uppermost portion of upper bellows 441. Upper bead 460 is sealingly engaged with bellows top plate 443 in a well-known manner. Upper bellows 441, rolling portion 448, air spring top plate 443, intermediate bellows 445, and intermediate top plate 491 define a bellows chamber 498 with an interior volume V₁d. An air spring mounting plate (not shown) may be mounted on the top surface of bellows top plate 443 by fasteners (not shown) which may be used to mount the top portion of air spring 424 to a respective main member (not shown) of a heavy-duty vehicle (not shown). Alternatively, top plate 443 could be mounted directly to a main member, as is known.

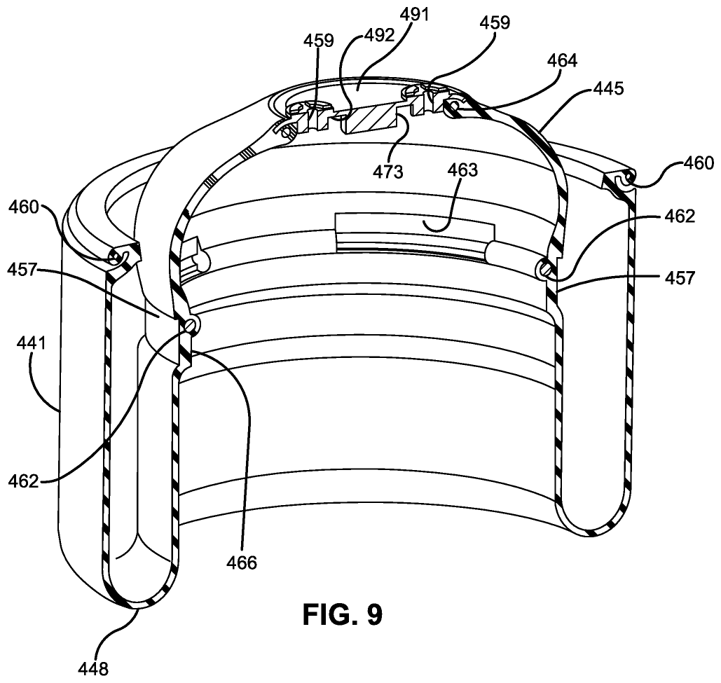

Middle bead 462 extends radially from bellows 440 between rolling portion 448 and intermediate bellows 445. Middle bead 462 is complementary-shaped to, and forms an interface with, groove 480 of protrusion 483 of piston top plate 482. In particular, middle bead 462 may be continuous or non-continuous such that the middle bead may be formed intermittently with one or more portions forming gaps 463 (FIG. 9). More particularly, middle bead 462 and gaps 463 correspond to groove 480 and the interruptions in the groove, respectively. A sealing surface 466 is formed circumferentially about bellows 440 adjacent to middle bead 462. Sealing surface 466 may be flat or may include any suitable surface feature or a series of surface features, such as textures, complementary and corresponding to the surface feature or series of surface features of sealing surface 487 of protrusion 483. As a result, middle bead 462 and sealing surface 466 of bellows 440 cooperate to form an airtight seal with groove 480 and sealing surface 487 of piston 442.

In particular, middle bead 462 may form a bayonet connection with groove 480 of piston top plate 482, allowing interaction between sealing surfaces 466, 487. More particularly, during assembly, bellows 440 is slidably disposed over protrusion 483 of piston top plate 482 such that gaps 463 and middle bead 462 are disposed about groove 480 and the interruptions in the groove, respectively, forming an interface between sealing surfaces 466, 487. Bellows 440 is then twisted or rotated about the circumference of protrusion 483 such that middle bead 462 operatively engages with and becomes disposed within groove 480, sealing the bellows to piston 442. Alternatively, groove 480 of protrusion 483 and middle bead 462 of bellows 440 may be formed continuously about the entire circumference of the protrusion and bellows, respectively. As a result, once bellows 440 is disposed over and about piston 442, middle bead 462 can engage and be disposed within the entire length of groove 480, forming a bead-in-groove connection.

It is contemplated that a circular hoop or band 456 may be used to maintain the airtight seal between sealing surfaces 466, 487 and retain middle bead 462 within groove 480. In particular, bellows 440 has a recess or groove 457 (FIG. 9) arranged about, and opposite to, middle bead 462 into which band 456 may be received. More particularly, during assembly, band 456 is slidably disposed over intermediate bellows 445 of bellows 440 to provide suitable compressive force to maintain contact between sealing surfaces 466, 487 and form an airtight seal. More specifically, band 456 may be formed with a dimension or diameter equivalent to or less than a dimension or diameter of groove 457 such that, once the band is seated in the groove, sufficient compressive force is exerted on middle bead 462 and sealing surface 466 to maintain the airtight seal. Alternatively, band 456 may be dimensionally altered after the band is disposed about groove 457. In particular, band 456 may be swaged or crimped once disposed about groove 457 in order to create and apply sufficient compressive force on middle bead 462 and sealing surface 466 to maintain the airtight seal between bellows 440 and piston 442. It is also contemplated that band 456 may be formed as a split ring or hoop that may be disposed about groove 457 and crimped, swaged, or otherwise secured to apply sufficient compressive force.

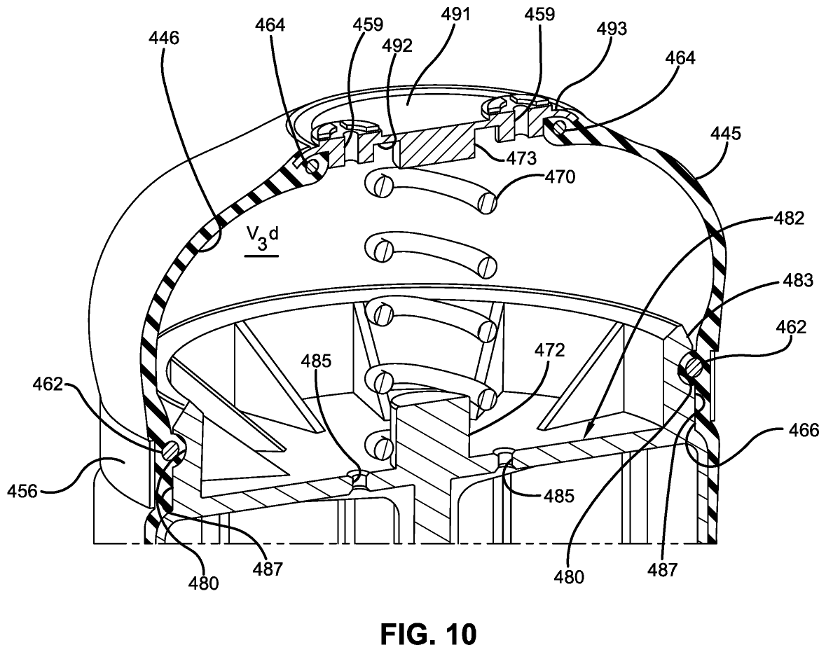

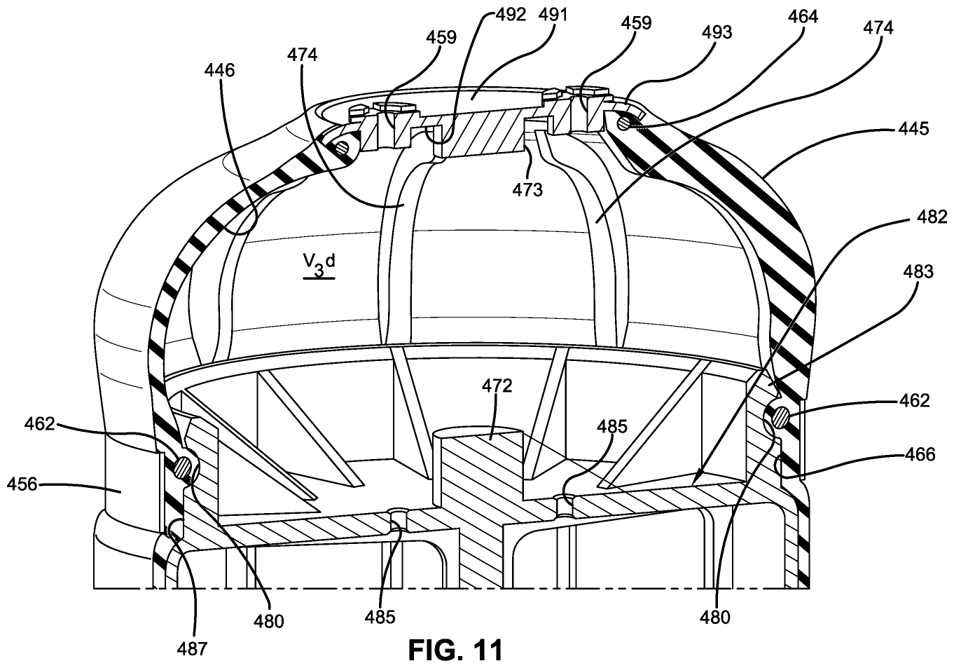

Intermediate chamber 446 is defined by intermediate bellows 445, intermediate top plate 491, and piston top plate 482 and includes an intermediate chamber volume V₃d. Intermediate chamber 446 generally extends away from piston top plate 482 into bellows chamber 498 such that intermediate top plate 491 is spaced between the piston top plate and bellows top plate 443 of air spring 424. Extension of intermediate chamber 446 into bellows chamber 498 increases a reserved volume between intermediate chamber volume V₃d and piston chamber volume V₂d, while decreasing bellows chamber volume V₁d. As a result, the damping energy of air spring 424 is increased without decreasing air spring travel or requiring additional space. Intermediate chamber 446 may include any suitable support structure disposed within the intermediate chamber or integrally formed with intermediate bellows 445. More preferably, intermediate chamber 446 includes a support structure or spring 470 (FIGS. 5 and 10) disposed within the intermediate chamber and/or a support structure integrally formed with intermediate bellows 445, such as reinforcing webs 474 (FIG. 11). Reinforcing webs 474 are formed in a circumferentially-spaced arrangement about intermediate bellows extending from or adjacent to middle bead 462 to intermediate top plate 491.

Spring 470 extends from piston top plate 482 and operatively connects to, or engages with, intermediate top plate 491. In particular, spring 470 is arranged centrally within intermediate chamber 446 such that it is aligned between central hub 452 and intermediate top plate 491. More particularly, spring 470 is disposed about and extends between a pair of projections 472, 473 extending from piston top plate 482 and intermediate top plate 491, respectively. Projection 472 may be integrally formed with piston top plate 482 or may be an extension of central hub 452 extending into intermediate chamber 446. Projection 473 is integrally formed with and extends from intermediate top plate 491 into intermediate chamber 446. An annular groove 492 is formed in intermediate top plate 491 about projection 473 to receive at least a portion of spring 470. Projections 472, 473 and groove 492 retain spring 470 in a central position within intermediate chamber 446 by acting to capture at least a portion of the spring about the projections and within a portion of the groove, thereby preventing the spring from sliding or tilting.

Spring 470 has a dimension and stiffness optimized to provide sufficient support to prevent collapse or flexion of intermediate chamber 446 due to pressure differentials between bellows chamber 498 and the intermediate chamber while providing sufficient flexibility to prevent obstruction of travel of air spring 424 during jounce events. As a result, the piston volume may be minimized and the packaging size of the air spring reduced, increasing the available space for heavy-duty vehicle cargo. In particular, the size of spring 470 is determined in relation to a diameter of intermediate top plate 491. More particularly, the size of spring 470 may be optimized to allow for optimal stiffness of the spring and minimal diameter of intermediate top plate 491. As a result, intermediate top plate 491 and spring 470 have reduced size and weight, reducing the cost of materials and manufacturing. Moreover, the reduction of the diameter of intermediate top plate 491 allows for easier telescoping of bellows 440 to facilitate attachment to piston 442 during assembly, thereby reducing manufacturing costs.

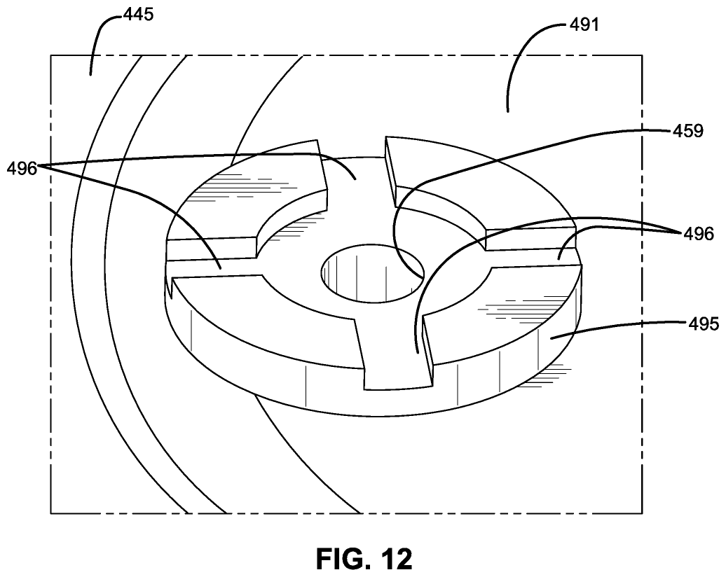

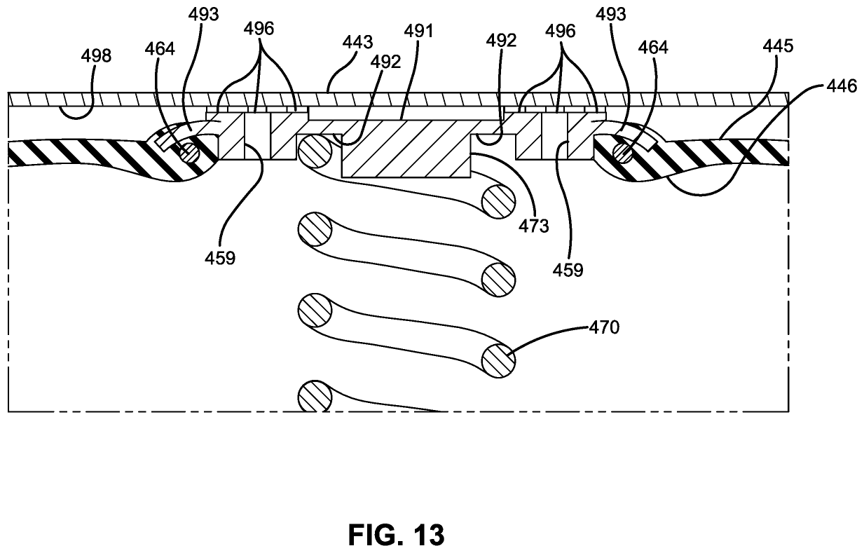

In accordance with another primary feature of the present invention, intermediate chamber 446 is in fluid communication with piston chamber 499 and bellows chamber 498. More specifically, one or more openings 485 are formed through piston top plate 482 and provide restricted fluid communication between intermediate chamber volume V₃d and piston chamber volume V₂d. One or more openings 459 are formed through intermediate top plate 491 of intermediate chamber 446 and provide restricted fluid communication between intermediate chamber volume V₃d and bellows chamber volume V₁d. Openings 459, 485 may have any suitable size or shape, such as oval, elliptical, or polygonal and may be formed at any location on intermediate top plate 491 and piston top plate 482, respectively. Openings 459 may be raised or extend from the surface of intermediate top plate 491 into bellows chamber 498 forming a flange 495 (FIG. 12). In particular, flange 495 may have a slotted or castellated structure extending from intermediate top plate 491 into bellows chamber 498 adjacent to openings 459. More particularly, the castellated structure of flange 495 provides one or more grooves or slots 496 arranged perpendicular to openings 459. Slots 496 may be of any suitable size and shape to allow fluid communication between openings 459 and bellows chamber 498 in the event top plate 443 contacts flange 495. Specifically, when bellows top plate 443 contacts intermediate top plate 491, as shown in FIG. 13, slots 496 of flange 495 prevent obstruction of fluid flow between bellows chamber 498 and intermediate chamber 446 through openings 459.

During operation, when axle 32 of axle/suspension system 10 experiences a jounce event, such as when the wheels (not shown) of the heavy-duty vehicle (not shown) encounter a curb or raised bump in the road, the axle moves vertically upwardly toward the heavy-duty vehicle chassis. In such a jounce event, upper bellows 441 and rolling portion 448 are compressed by the axle/suspension system as the wheels travel over the curb or raised bump in the road. The compression of upper bellows 441 and rolling portion 448 causes the internal pressure of bellows chamber 498 to increase. As a result, a pressure differential is created between bellows chamber 498 and intermediate chamber 446. This pressure differential begins to compress intermediate bellows 445 while spring 470 and/or reinforcing webs 474 react to provide support and prevent collapse of intermediate chamber 446. The pressure differential between bellows chamber 498 and intermediate chamber 446 also causes air to flow from bellows chamber 498 through openings 459 into intermediate chamber 446. The flow of air into intermediate chamber 446 creates a pressure differential between the intermediate chamber and piston chamber 499. This pressure differential causes air to flow from intermediate chamber 446 through openings 485 into piston chamber 499. The flow of air back and forth between bellows chamber 498 and piston chamber 499 through intermediate chamber 446 and openings 459, 485 causes increased damping to occur across critical frequency ranges from about 1.2 to about 2 Hz and from about 8 to about 15 Hz. Air continues to flow back and forth among piston chamber 499, intermediate chamber 446, and bellows chamber 498 until the pressures in the piston chamber, the intermediate chamber, and the bellows chamber have equalized.

In an extreme jounce event, upper bellows 441 and rolling portion 448 become rapidly compressed by axle/suspension system 10 as the wheels of the heavy-duty vehicle travel over the curb or the raised bump in the road. The extreme compression of upper bellows 441 and rolling portion 448 causes bellows top plate 443 to contact and apply force or pressure to intermediate top plate 491. More specifically, bellows top plate 443 contacts the castellated structure of flanges 495. However, slots 496 remain unobstructed, allowing restricted fluid flow of air back and forth between bellows chamber 498 and intermediate chamber 446 through openings 459. As a result, the damping energy generated by air spring 424 is maintained. Moreover, the rapid compression of bellows 441 and rolling portion 448 creates a relatively larger pressure differential between bellows chamber 498 and intermediate chamber 446 than occurs during a normal jounce event. However, unlike prior art air springs 224, 324, the acute bias angle A of the reinforcing layers of material of upper bellows 441 prevent radial expansion of the bellows. As a result, bellows chamber volume V₁d, and thus the damping energy of air spring 424, is maintained. Furthermore, the contact between bellows top plate 443 and intermediate top plate 491 causes intermediate bellows 445 to begin to compress allowing additional compression of air spring 424, collapsing intermediate chamber 446, and causing a build-up of elastic energy within spring 470, reinforcing webs 474, and/or the intermediate bellows. The remaining force exerted on top plate 443 is transferred through intermediate top plate 491, spring 470, central hub 452, and support walls 453 of piston 442 to bottom plate 450 and beam 18 of axle/suspension system 10, on which air spring 424 is mounted.

When axle 32 of axle/suspension system 10 experiences a rebound event, such as when the wheels of the heavy-duty vehicle encounter a large hole or depression in the road, the axle moves vertically downwardly away from the heavy-duty vehicle chassis. In such a rebound event, upper bellows 441 and rolling portion 448 are extended as the wheels of the heavy-duty vehicle travel into the hole or depression in the road. The extension of air spring upper bellows 441 and rolling portion 448 causes the internal pressure of bellows chamber 498 to decrease. As a result, a pressure differential is created between bellows chamber 498 and intermediate chamber 446. This pressure differential causes air to flow from intermediate chamber 446 through openings 459 into bellows chamber 498. Air flow from intermediate chamber 446 to bellows chamber 498 reduces air pressure within the intermediate chamber, resulting in a pressure differential between the intermediate chamber and piston chamber 499. This pressure differential causes air to flow from piston chamber 499 through openings 485 into intermediate chamber 446. The flow of air back and forth among piston chamber 499, intermediate chamber 446, and bellows chamber 498 through openings 485, 459 causes an increase in damping across critical frequency ranges from about 1.2 to about 5 Hz and from about 8 to about 15 Hz. Air continues to flow back and forth among piston chamber 499, intermediate chamber 446, and bellows chamber 498 until pressure within the piston chamber, the intermediate chamber, and the bellows chamber has equalized.

In an extreme rebound event, upper bellows 441 and rolling portion 448 extend rapidly. As a result, bellows top plate 443 moves upwardly, separating from and relieving force or pressure on intermediate top plate 491. Intermediate bellows 445 extends as elastic energy stored in the intermediate bellows and spring 470 is released, causing intermediate chamber 446 to regain its original shape within bellows chamber 498. The suitable compressive force of band 456 on middle bead 462 and sealing surface 466 of bellows 440 and groove 480 and sealing surfaces 487 of protrusion 483 of piston top plate 482, prevents the bellows from becoming separated from piston 442 or losing air, thereby preventing potential damage to air spring 424 and/or other components of axle/suspension system 10.

Exemplary embodiment damping air spring 424, according to the present invention, overcomes the problems associated with prior art air springs 124, 224, 324, by providing continuous bellows 440 having additional layers of material with an acute bias angle A relative to each other, which provides radial resistance to changes in the diameter of upper bellows 441 and prevents increases in bellows chamber volume V₁d to maintain damping energy during extreme jounce events, and having intermediate chamber 446, which reduces bellows chamber volume V₁d while increasing the reserved volume between intermediate chamber volume V₃d and piston chamber volume V₂d, and optimizes damping across body bounce mode and wheel hop mode critical frequency ranges to accommodate a broader range of loads and wheel motions and increase damping energy without limiting or changing travel of the air spring, thereby reducing or eliminating frequency dependence and reducing the constraints on the operating range of the air spring. Intermediate chamber 446 includes spring 470 and/or other support structure with optimized size and stiffness to support and prevent collapse of intermediate chamber 446 due to fluid pressure differentials, while allowing the intermediate chamber to be flexible. Spring 470 is optimized in relation to intermediate top plate 491, which has an optimized or minimized diameter, further reducing the cost of material and manufacturing. Bellows 440, including intermediate bellows 445, rolling portion 448, and upper bellows 441 is formed as a single continuous unit, reducing the cost and complexity of materials and manufacturing. Bellows 440 is attached to piston 442 utilizing a bead-in-groove or bayonet connection between middle bead 462, groove 480, sealing surfaces 466, 487, and/or retaining band 456, to provide a more secure connection to the piston than prior art air springs 124, 224, 324 and preventing air loss and/or damage to air spring 424 and/or other components of axle/suspension system 10. Slots 496 of the castellated structure of flanges 495 prevent obstruction of openings 459 in intermediate top plate 491, allowing air spring 424 to maintain damping energy in the event bellows top plate 443 contacts the intermediate top plate during extreme jounce events.

It is contemplated that exemplary embodiment damping air spring 424 could be utilized on any heavy-duty vehicle, including buses, trucks, tractor-trailers, trailers, and the like, having one or more than one axle without changing the overall concept or operation of the present invention. It is also contemplated that air spring 424 could be utilized on any heavy-duty vehicles having frames or subframes, which are moveable or non-movable, without changing the overall concept or operation of the present invention. It is further contemplated that air spring 424 could be utilized on all types of air-ride beam-type axle/suspension system designs known to those skilled in the art, such as overslung/top-mount or underslung/bottom-mount, spring-beam, non-torque-reactive, independent, and 4-bag axle/suspension systems, including axle/suspension systems using U-bolts, U-bolt brackets/axle seats, and the like, or other types of suspensions without changing the overall concept or operation of the present invention. It is even contemplated that air spring 424 could be utilized in combination with prior art shock absorbers without changing the overall concept or operation of the present invention.

It is contemplated that exemplary embodiment air spring 424 could be formed from any suitable material or combination of materials, including composites, metal, and the like, without changing the overall concept or operation of the present invention. It is also contemplated that openings 459, 485 of exemplary embodiment air spring 424 could be formed in any suitable location on intermediate top plate 491 and piston top plate 482, respectively, including other than those shown and described, without changing the overall concept or operation of the present invention. It is further contemplated that any number of openings 459, 485 from a single opening to multiple openings, having any suitable size or shape may be formed in intermediate top plate 491 and piston top plate 482, respectively, without changing the overall concept or operation of the present invention. It is yet further contemplated that the concepts shown in exemplary embodiment air spring 424 could be utilized individually or in any combination in any type of air spring utilized in conjunction with heavy-duty vehicles, without changing the overall concept or operation of the present invention. It is yet even further contemplated that prior art air spring bellows, such as bellows 141, 241, 341, may be modified to include the bayonet connection of exemplary embodiment air spring 424, including middle bead 462, gaps 463, groove 480, sealing surfaces 466, 487, and/or band 456 to provide a more secure connection between the prior art bellows and prior art piston 142, 242, 342, respectively, and prevent dislodgement or separation of the prior art bellows during jounce and rebound events.

Accordingly, the exemplary embodiment air spring of the present invention is simplified; provides an effective, safe, inexpensive, and efficient structure and method that achieves all the enumerated objectives; provides for eliminating difficulties encountered with prior air springs; and solves problems and obtains new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed. The present invention has been described with reference to a specific embodiment. It is to be understood that this illustration is by way of example and not by way of limitation. Potential modifications and alterations will occur to others upon a reading and understanding of this disclosure, and it is understood that the invention includes all such modifications, alterations, and equivalents thereof.

Having now described the features, discoveries and principles of the invention; the manner in which the air spring is used and installed; the characteristics of the construction, arrangement, and method steps; and the advantageous, new and useful results obtained, the new and useful structures, devices, elements, arrangements, process, parts, and combinations are set forth in the appended claims.

What is claimed is:

1. An air spring for a heavy-duty vehicle axle/suspension system comprising:
a piston;
a bellows having a bellows chamber; and
an intermediate chamber, said intermediate chamber having a top plate and at least one support structure, said at least one support structure being optimized in relation to said top plate.

2. The air spring of claim 1, said at least one support structure further comprising a spring disposed within said intermediate chamber.

3. The air spring of claim 2, said spring being optimized to have a spring constant that prevents said intermediate chamber from collapsing due to a pressure differential between said bellows chamber and the intermediate chamber.

4. The air spring of claim 3, said spring being optimized to have a spring constant that allows said intermediate chamber to be compressed when said intermediate top plate is contacted by a bellows top plate.

5. An air spring for a heavy-duty vehicle axle/suspension system comprising:
a piston; and
a bellows having a bellows chamber, said bellows being connected to said piston by at least one means for connection chosen from the group consisting of a band, a bead-in-groove connection, and a bayonet connection.

6. The air spring of claim 5, said piston further comprising a sealing surface formed about a circumference of said piston; and
said bellows further comprising another sealing surface formed about a circumference of said bellows.

7. The air spring of claim 6, said bellows being disposed about said piston; and
said piston sealing surface and said bellows sealing surface being aligned.

8. The air spring of claim 7, said band being disposed about said bellows and said piston, the band applying sufficient compressive force to the bellows to form an interface between said piston sealing surface and bellows sealing surface.

9. The air spring of claim 7, said piston further comprising a groove formed about said circumference of the piston; and
said first piston surface being adjacent to said groove.

10. The air spring of claim 9, said bellows further comprising a bead integrally formed about said circumference of the bellows and projecting radially away from said bellows; and
said bellows sealing surface being adjacent to said bead.

11. The air spring of claim 10, said bead-in-groove connection further comprising:
said bead being disposed within said groove; and
said piston sealing surface being aligned and forming an interface with said bellows sealing surface.

12. The air spring of claim 11, said bayonet connection further comprising said bellows being disposed about said piston, said piston sealing surface being aligned and forming an interface with said bellows sealing surface, the bayonet connection being rotatable between a first position and a second position;
wherein said bead has at least one flat area aligned with said groove, and the groove has at least one gap aligned with the bead in said first position; and
wherein said at least one flat area is aligned with said at least one gap, and said bead is disposed within said groove in said second position.

13. The air spring of claim 5, said piston further comprising a top plate, said piston top plate having a means for restricted fluid communication between said bellows chamber and said piston chamber to provide damping.

14. The air spring of claim 13, said air spring further comprising a compressible intermediate chamber extending from said piston into and occupying a portion of said bellows chamber;
wherein said intermediate chamber provides the air spring with increased damping without limiting travel of said air spring or increasing the amount of space required for the air spring in said axle/suspension system.

15. The air spring of claim 14, said intermediate chamber having an intermediate bellows, said intermediate bellows and said bellows being formed as a single continuous unit, said single continuous unit being partially inverted prior to installation onto said piston.

16. The air spring of claim 15, said intermediate chamber further comprising a top plate, said top plate being formed with a flange.

17. The air spring of claim 16, said piston further comprising a top plate, said piston top plate having a means for restricted fluid communication between said intermediate chamber and said piston chamber; and
said intermediate top plate having another means for restricted fluid communication between said bellows chamber and the intermediate chamber.

18. The air spring of claim 17, said piston top plate means for restricted fluid communication and said intermediate top plate means for restricted fluid communication each further comprising at least one opening.

19. The air spring of claim 16, said intermediate bellows further comprising a bead integrally formed about said circumference of the intermediate bellows and projecting radially away from said bellows and a groove adjacent to said bead.

20. The air spring of claim 19, said bead being molded and cured together with said intermediate top plate; and
said flange being molded into said groove and fixedly connected to said intermediate bellows.

21. An air spring for a heavy-duty vehicle axle/suspension system comprising:
a piston; and
a bellows with a bellows chamber, said bellows having an upper portion, said upper portion being reinforced to prevent said bellows chamber from increasing in volume.

22. The air spring of claim 21, said upper bellows being reinforced with at least one cord cloth layer molded to said upper portion.

23. The air spring of claim 22, said at least one cord cloth layer having an orientation, said cord cloth layer orientation being at an angle relative to an orientation of said bellows material.

24. The air spring of claim 23, said angle being less than 60 degrees.

25. An air spring for a heavy-duty vehicle axle/suspension system comprising:
a piston; and
a bellows having a bellows chamber and a top plate;
an intermediate chamber extending from said piston into said bellows chamber, said intermediate chamber having an intermediate top plate formed with means for restricted fluid communication between said bellows chamber and the intermediate chamber, said bellows top plate being capable of contacting said intermediate top plate and said means for restricted fluid communication during jounce events without said means being obstructed.

26. The air spring of claim 25, said means for restricted fluid communication further comprising at least one opening having a raised flange.

27. The air spring of claim 26, said flange further comprising a castellated structure extending from said intermediate chamber top plate into said bellows chamber, said castellated structure having at least one groove formed orthogonally in the flange, said at least one groove allowing restricted fluid communication between said bellows chamber and said intermediate chamber when said bellows top plate contacts said intermediate chamber top plate.
